(19) United States
(12) Patent Application Publication
(10) Pub. No.: US 2014/0169937 A1
(43) Pub. Date: Jun. 19, 2014

(54) MIXER-EJECTOR TURBINE WITH ANNULAR AIRFOILS

(71) Applicant: FloDesign Wind Turbine Corp., Waltham, MA (US)

(72) Inventors: Daniel Gysling, South Glastonbury, CT (US); Ercan Dumlupinar, Palmer, MA (US)

(73) Assignee: FLODESIGN WIND TURBINE CORP., Waltham, MA (US)

(21) Appl. No.: 14/133,547

(22) Filed: Dec. 18, 2013

Related U.S. Application Data
(60) Provisional application No. 61/738,600, filed on Dec. 18, 2012.

(51) Int. Cl. F03D 1/04

(52) U.S. Cl. CPC F03D 1/04
USPC 415/1; 415/228; 415/144

(57) ABSTRACT

Example embodiments are directed to fluid turbines that include a turbine shroud, a rotor and an ejector shroud. The turbine shroud includes an inlet, an outlet, a leading edge and a trialing edge. The leading edge of the turbine shroud can be round and the trialing edge of the turbine shroud can include linear faceted segments. The rotor can be disposed within the turbine shroud and can define a rotor plane. The turbine shroud can provide a first portion of a fluid stream to the rotor plane via the inlet of the turbine shroud. The ejector shroud can provide a second portion of the fluid stream to the outlet of the turbine shroud via an open area. An example method of operating a fluid turbine is also provided.

### CROSS-REFERENCE TO RELATED APPLICATIONS

The present application claims the benefit of a U.S. provisional patent application entitled “Mixer-Ejector Turbine With Annular Airfoils” which was filed on Dec. 18, 2012, and assigned Ser. No. 61/738,600. The entire content of the foregoing provisional application is incorporated herein by reference.

### TECHNICAL FIELD

The present disclosure relates to turbines for power generation and, in particular, to fluid turbines including multiple-element airfoils which increase a pressure downstream of the fluid turbine to increase an amount of power extracted from a rotor.

### BACKGROUND

Conventionally, horizontal axis fluid turbines, e.g., wind turbines, and the like, used for power generation include two to five bladed rotors joined at a central hub, and include a rotor for the purpose of energy capture from a fluid stream. An open rotor can capture energy from a fluid stream that is smaller in diameter than the rotor. As fluid flows from the upstream side of an open rotor to the downstream side, the fluid velocity remains constant as it passes through the rotor plane. Energy is extracted at the rotor and results in a pressure drop on the downstream side. The air directly behind the turbine is at sub-atmospheric pressure, while the air in front of the turbine is under greater than atmospheric pressure. The high pressure in front of the turbine deflects some of the upstream air around the rotor. In other words, a portion of the fluid stream is diverted around the rotor as by an impediment. As it is diverted around the rotor, the stream expands. This can be referred to as flow expansion at the rotor. Due to the flow expansion, the upstream area of the fluid flow is smaller than the area of the rotor.

In a ducted turbine, the upstream area of the fluid stream is larger than the area of the rotor. The fluid stream is contracted at the rotor plane by the duct and expands after leaving the duct. The energy that may be harvested from the fluid is proportional to the upstream area where the fluid stream starts in a non-contracted state. In a conventional diffuser augmented turbine, the diffuser surrounds the rotor such that the diffuser guides incoming fluid prior to the fluid interaction with the rotor, providing the greatest unit-mass flow rate substantially proximal to the rotor plane. Expansion of the flow is delayed to the area downstream of the rotor at the trailing edge of the duct. The upstream area of the fluid stream is larger than the area of the rotor plane due to the flow contraction at the duct.

### SUMMARY

In accordance with example embodiments of the present disclosure, fluid turbines are provided that include one or more faceted turbine shrouds. In some embodiments, the fluid turbines include a turbine shroud which includes a round leading edge and a faceted trailing edge formed from faceted segments. For example, the structure of the turbine shroud can transition from the round leading edge to planar, faceted surfaces and edges, for example, faceted segments at the trailing edge. In some embodiments, the leading edge of the fluid turbine can also be faceted. In some embodiments, the fluid turbines include an ejector shroud positioned in fluid communication with the turbine shroud which includes faceted leading and trailing edges. Faceted shrouds can reduce the cost of manufacturing and/or assembling fluid turbines by utilizing flat stock material and/or extruded forms in place of molded round forms. Thus, faceted shrouds can minimize costs of manufacturing, while providing the advantageous aerodynamic properties discussed herein.

In accordance with example embodiments of the present disclosure, fluid turbines are provided that include a turbine shroud, a rotor and an ejector shroud. The turbine shroud can include an inlet defined by a leading edge and an outlet defined by a trialing edge. The leading edge of the turbine shroud can be round and the trialing edge of the turbine shroud can include faceted surfaces and edges, e.g., a plurality of linear and constant cross-section faceted segments. The rotor can be disposed within the turbine shroud. The rotor can include a hub and at least one rotor blade engaged with the hub. The rotor can define a rotor plane. The turbine shroud can provide a first portion of a fluid stream to the rotor plane via the inlet of the turbine shroud. The ejector shroud can include an ejector shroud inlet and an ejector shroud outlet. The ejector shroud inlet can be in fluid communication with the outlet of the turbine shroud. The ejector shroud can provide a second portion of the fluid stream to the outlet of the turbine shroud via an open area. The open area can be defined by an area of the ejector shroud inlet less an area of the outlet of the turbine shroud.

The rotor can be disposed downstream of the inlet of the turbine shroud. The ejector shroud inlet can define a leading edge and the ejector shroud outlet can define the trailing edge of the ejector shroud. In some embodiments, the leading edge and the trailing edge of the ejector shroud include faceted surfaces and edges, e.g., a plurality of linear and constant cross-section faceted segments. In some embodiments, the ejector shroud includes faceted surfaces and edges horizontally oriented and positioned at a 12:00 o'clock and a 6:00 o'clock position.

The second portion of the fluid stream can be a bypass flow. In some embodiments, the ejector shroud can provide the bypass flow to a resultant flow wake of the first portion of the fluid stream of the fluid turbine to increase a pressure downstream of the rotor. In some embodiments, the ejector can increase a unit mass flow through the turbine shroud by increasing a camber of the turbine shroud. In some embodiments, increasing the camber of the turbine shroud can increase a lift coefficient on an inner surface of the turbine shroud.

In accordance with example embodiments of the present disclosure, methods of operating a fluid turbine are provided that include providing a fluid turbine. The fluid turbine can include a turbine shroud, a rotor and an ejector shroud, as described herein. The methods include positioning the ejector shroud inlet in fluid communication with the outlet of the turbine shroud. The methods include providing a first portion of a fluid stream to the rotor plane via the inlet of the turbine shroud. The methods further include providing a second portion of the fluid stream to the outlet of the turbine shroud via an open area. The open area can be defined by an area of the ejector shroud inlet less an area of the outlet of the turbine shroud.

In some embodiments, the methods include providing bypass from with the ejector shroud to a resultant flow wake of the first portion of the fluid stream downstream of the outlet of the turbine shroud. Providing bypass flow can include increasing a pressure downstream of the rotor by creating turbulent mixing between the bypass flow and the resultant flow wake. Increasing the pressure downstream of the rotor can allow greater energy extraction at the rotor from the fluid stream. In some embodiments, the methods include increasing a unit mass flow through the turbine shroud with the ejector shroud by increasing a camber of the turbine shroud. Increasing the camber of the turbine shroud can include increasing a lift coefficient on an inner surface of the turbine shroud.

In accordance with example embodiments of the present disclosure, fluid turbines are provided that include a turbine shroud, a rotor and an ejector shroud. The turbine shroud can include an inlet and an outlet. The rotor can be disposed within the turbine shroud. The rotor can include a hub and at least one rotor blade engaged with the hub. The rotor can define a rotor plane. The turbine shroud can provide a first portion of a fluid stream to the rotor plane via the inlet of the turbine shroud.

The ejector shroud can include an ejector shroud inlet, an ejector shroud outlet, a leading edge and a trailing edge. The leading edge and the trailing edge of the ejector shroud can include faceted surfaces and edges, e.g., a plurality of linear and constant cross-section faceted segments. The ejector shroud inlet can be in fluid communication with the outlet of the turbine shroud. The ejector shroud can provide a second portion of the fluid stream to the outlet of the turbine shroud via an open area. The open area can be defined by an area of the ejector shroud inlet less an area of the outlet of the turbine shroud.

In some embodiments, the turbine shroud can include a turbine shroud leading edge and a turbine shroud trailing edge. In some embodiments, the turbine shroud leading edge can be round and the turbine shroud trailing edge can include faceted surfaces and edges, e.g., a plurality of linear and constant cross-section faceted segments.

In accordance with example embodiments of the present disclosure, fluid turbines, e.g., shrouded liquid turbines, shrouded air turbines, and the like, are provided that include a duct including a ringed airfoil which provides a lift coefficient on the inner surface of the ring. Multiple element airfoils can increase the camber of an airfoil and raise the maximum lift coefficient. An increased lift coefficient of a ringed airfoil surrounding a turbine can reduce the minimum fluid velocity at which the turbine is able to operate, and can be referred to as a reduction in the cut-in speed of the turbine. Multiple element airfoils can provide a means for introducing bypass flow into the wake of the turbine.

The present disclosure relates to fluid turbines of a particular structure, more specifically, to a fluid turbine providing power extraction improvements to an open rotor including a multiple-element airfoil. Some embodiments include annular airfoils with faceted segments, e.g., at least one annular airfoil, in fluid communication with the circumference of a rotor plane. Some embodiments are configured with annular airfoils without faceted segments.

Annular airfoils include an inlet defined by a leading edge and an exit defined by a trailing edge with the lift or suction side of the airfoils on the side proximal to the rotor. The fluid stream can be divided into a low pressure-high velocity stream on the interior side of the airfoil, and a high pressure-lower velocity stream on the exterior of the airfoil. The higher pressure-lower velocity stream can be the bypass flow.

Those of ordinary skill in the art should understand that the example ducts or shrouds discussed herein can deliver a greater mass flow rate to the interior of the duct than to an open rotor. Improved performance over that of an open rotor, from a rotor in fluid communication with a designated duct, can be achieved due to a reduction of rotor-tip vortices and the increased unit mass flow through the duct. Duct augmented wind turbines can employ bypass ducts or multi-element annular airfoils for the purpose of preventing flow separation from the interior of the duct. Introducing a relatively small volume of bypass flow to the turbine wake can be sufficient to maintain flow attachment over the interior surface of the duct. A mixer-ejector turbine can introduce a greater volume of bypass flow into the wake of the turbine for the purpose of extracting more energy at the rotor.

In some example embodiments, mixer-ejector turbines include mixing elements, such as diverging and converging airfoil segments. Such mixing elements provide controlled stream-wise vorticity in the area downstream of the mixer-ejector turbine while incurring increased friction losses due to the increased area of the mixing elements.

In some example embodiments, the cross-section of the annular airfoil can be configured as a multiple-element airfoil. A multi-element airfoil provides increased unit mass flow through the duct by increasing the lift coefficient of the airfoil. A multi-element airfoil provides the introduction of bypass flow into the rotor wake, thereby mixing bypass flow with the flow that has passed through the rotor.

In an example embodiment, multi-element airfoils can serve to assist in the combining of the bypass flow with the flow that has passed through the rotor plane. The combination primary annular airfoil, and at least one additional annular airfoil(s), includes a fluid turbine providing increased power extraction and efficiency over open rotor turbines.

In accordance with embodiments of the present disclosure, example fluid turbines are provided that include a rotor in communication with a generator. The rotor includes a rotor plane passing therethrough. The fluid turbines include a first annular airfoil or shroud and a second annular airfoil or shroud. The first annular airfoil can be in fluid communication with the rotor and includes a first inlet area and an exit area. The second annular airfoil can be in fluid communication with the exit area of the first annular airfoil and includes a second inlet area. The first annular airfoil can provide a first portion of a free-stream fluid flow to the rotor plane via the first inlet area of the first annular airfoil. The second annular airfoil can provide a second portion of the free-stream fluid to an exit stream of the first annular airfoil via an open area including the second inlet area of the second annular airfoil less the exit area of the first annular airfoil.

The first annular airfoil includes a first leading edge and a first trailing edge. In some embodiments, the first leading edge can be substantially round. The first trailing edge includes a first plurality of substantially linear and substantially constant cross-section faceted segments forming a faceted annular trailing edge. The second annular airfoil includes a second leading edge and a second trailing edge. The second leading edge and the second trailing edge of the second annular airfoil can include a second plurality of substantially linear and substantially constant cross-section faceted segments forming a faceted annular airfoil.

Fluid turbines in accordance with the present invention can be used to extract energy from a variety of suitable fluids such as air (e.g., wind) or water. The aerodynamic principles of a wind turbine of the present invention also apply to hydrodynamic principles of a comparable water turbine and can be employed in conjunction with numerous fluid turbines.

Other objects and features will become apparent from the following detailed description considered in conjunction with the accompanying drawings. It is to be understood, however, that the drawings are designed as an illustration and not as a definition of the limits of the invention.

### BRIEF DESCRIPTION OF THE DRAWINGS

To assist those of skill in the art in making and using the disclosed fluid turbines and associated methods, reference is made to the accompanying figures, wherein:

FIG. 1 is a front, right perspective view of an example turbine of the present disclosure;

FIG. 2 is a rear, right perspective view of an example turbine of FIG. 1;

FIG. 3 is a front, orthographic view of an example turbine of FIG. 1;

FIG. 4 is a side view of an example turbine of FIG. 1;

FIG. 5 is a side, orthographic, detailed section view of an example turbine of FIG. 4;

FIG. 6 is a front, right perspective view of another example turbine of the present disclosure;

FIG. 7 is a front, orthographic view of an example turbine of FIG. 6;

FIG. 8 is a front, right perspective view of another example turbine of the present disclosure; and

FIG. 9 is a front, perspective, cut-away view of an example turbine of FIG. 8.

### DESCRIPTION

As discussed in greater detail below, fluid turbines are provided that include one or more faceted turbine shrouds. In some embodiments, the fluid turbines include a turbine shroud which includes a round leading edge and a faceted trailing edge. For example, the structure of the turbine shroud can transition from the round leading edge to planar, faceted surfaces and edges, for example, faceted segments at the trailing edge. In some embodiments, the leading edge of the fluid turbine can also be faceted. In some embodiments, the fluid turbines include an ejector shroud positioned in fluid communication with the turbine shroud which includes faceted leading and trailing edges. Faceted shrouds can reduce the cost of manufacturing and/or assembling fluid turbines by utilizing flat stock material and/or extruded forms in place of molded round forms. Thus, faceted shrouds can minimize costs of manufacturing, while providing the advantageous aerodynamic properties discussed herein.

A more complete understanding of the components, processes, and apparatuses disclosed herein can be obtained by reference to the accompanying figures. These figures are intended to demonstrate the present disclosure and are not intended to show relative sizes and dimensions or to limit the scope of the disclosed embodiment(s).

Although specific terms are used in the following description, these terms are intended to refer only to particular structures in the drawings and are not intended to limit the scope of the present disclosure. It is to be understood that like numeric designations refer to components of like function.

The term “about” or “approximately” when used with a quantity includes the stated value and also has the meaning dictated by the context. For example, it includes at least the degree of error associated with the measurement of the particular quantity. When used in the context of a range, the term “about” or “approximately” should also be considered as disclosing the range defined by the absolute values of the two endpoints. For example, the range “from about 2 to about 4” or “from approximately 2 to approximately 4” also discloses the range “from 2 to 4.”

A shrouded turbine of the present disclosure provides an improved fluid turbine for extracting power from a fluid stream. At least one substantially annular airfoil can be in fluid communication with a rotor. The term “rotor” can be used herein to refer to any assembly in which one or more blades or blade segments are attached to a shaft and able to rotate, allowing for the generation or extraction of power or energy from fluid flow rotating the blade(s) or blade segments. Example rotors may include a propeller-like rotor, a rotor/stator assembly, a multi-segment propeller-like rotor, or any type of rotor understood by one skilled in the art that may be associated with the ringed airfoil of the present disclosure. As used herein, the term “blade” is not intended to be limiting in scope and includes all aspects of suitable blades, including those having multiple associated blade segments.

The leading edge of a turbine shroud can be considered the front of the fluid turbine, and the trailing edge of a ringed airfoil can be considered the rear of the fluid turbine. A first component of the fluid turbine located closer to the front of the turbine can be considered “upstream” of a second component located closer to the rear of the turbine. Stated another way, the second component can be considered “downstream” of the first component.

In an example embodiment, the present disclosure relates to a fluid turbine including a rotor in combination with at least one annular airfoil referred to as a turbine shroud. In one embodiment the annular airfoil includes a substantially annular leading edge form in fluid communication with the circumference of a rotor plane. The annular leading edge can transition to a trailing edge with faceted segments, otherwise referred to as a hybrid polygonal airfoil. In some embodiments, a second annular airfoil can be in fluid communication with the trailing edge of the turbine shroud. The second airfoil can be referred to as an ejector shroud and can be co-axial with the turbine shroud. The ejector shroud can be configured as a faceted, annular airfoil. One skilled in the art should understand that a faceted airfoil can include any number of facets or can be a ringed airfoil. Although example embodiments discussed and shown herein are substantially symmetrical, asymmetrical configurations should be considered within the scope of the present invention.

In some embodiments, annular airfoils with relatively shorter chord lengths and without mixing elements can be provided, as compared to mixer-ejector turbines with converging and diverging mixing elements. A relatively shorter chord length in a turbine shroud and a ejector shroud can provide the aerodynamic benefits of a mixer-ejector turbine with mixing elements and a relatively longer chord length, without drawbacks, such as that of excessive mass and loads. In some embodiments, efficiency losses may be incurred due to the reduced control of the mixing vortices. In some embodiments, significant benefits can result from the reduced cost of structure, and reduced weight and loads.

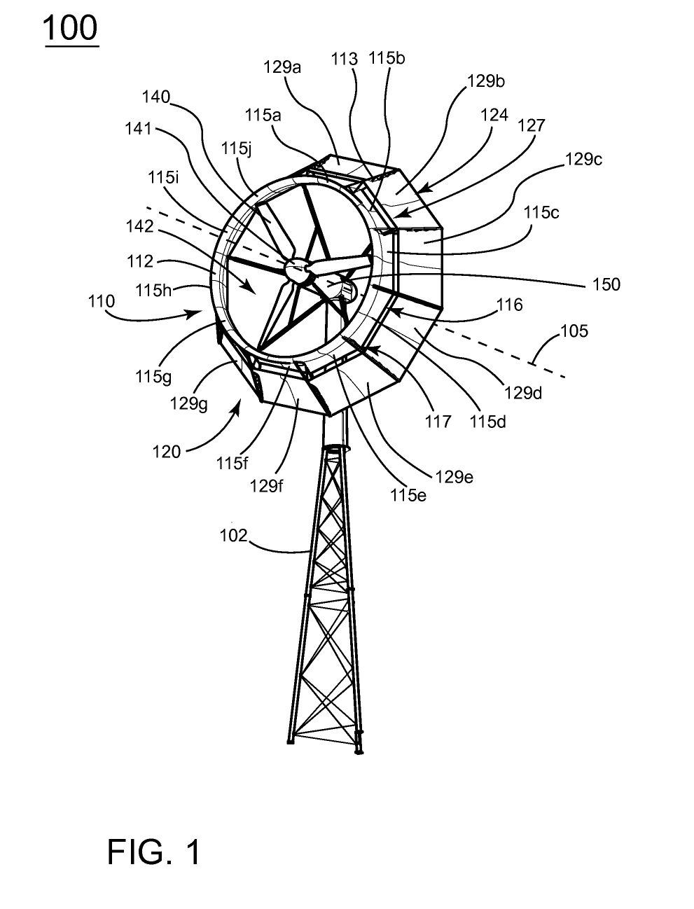

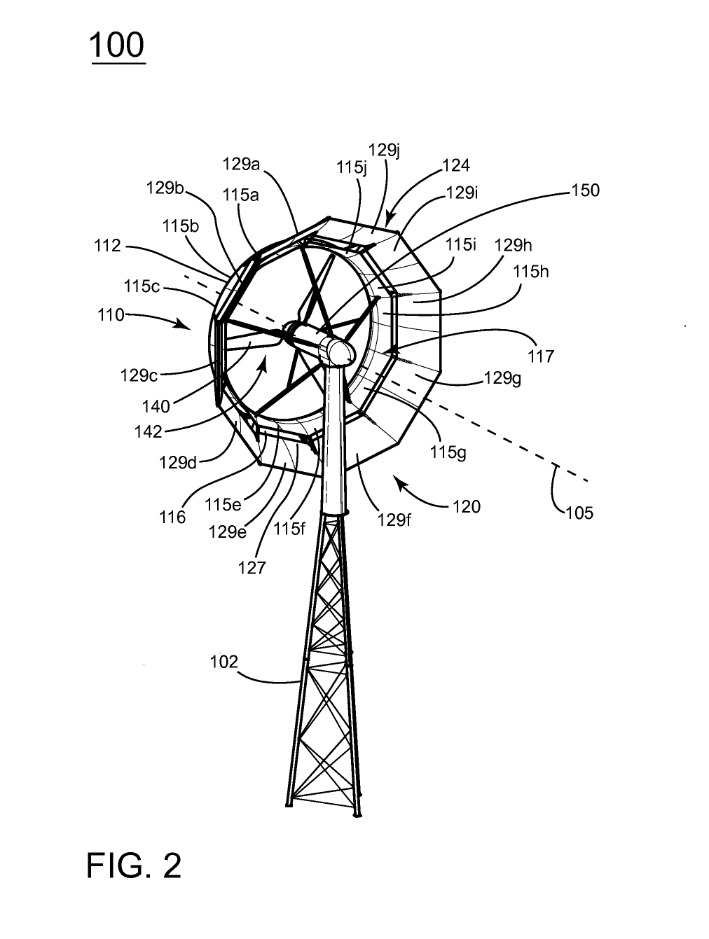

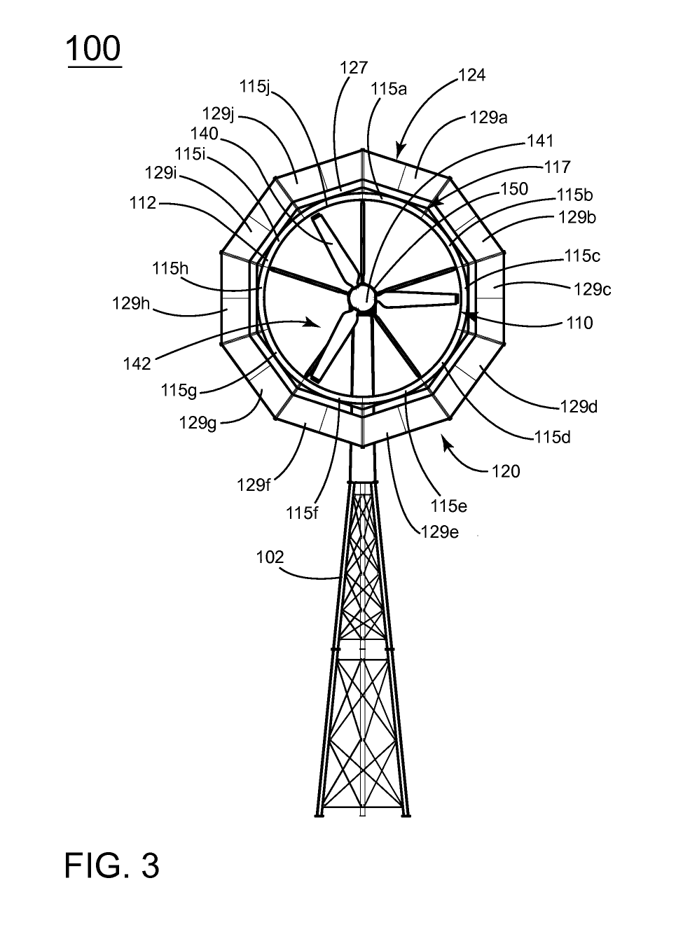

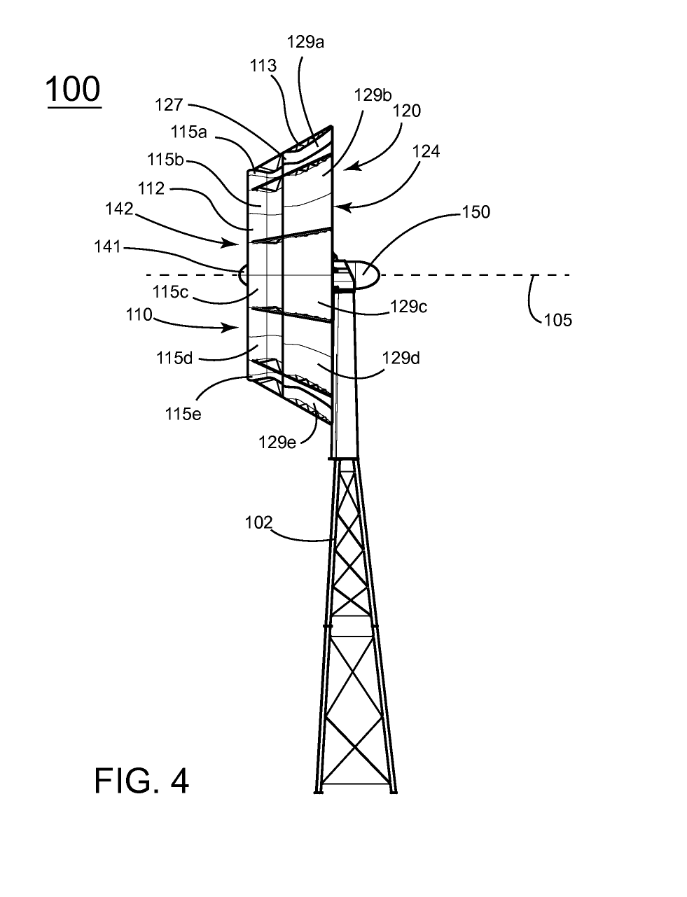

FIG. 1 is a right, front perspective view of an example embodiment of a fluid turbine 100 of the present disclosure. FIG. 2 is a rear, perspective view of the fluid turbine 100. FIG. 3 is a rear, orthographic view of the fluid turbine 100. FIG. 4 is a side, orthographic view of the fluid turbine 100. The fluid turbine 100 can include one or more rotor blades 140 that are joined at a central hub 141 and rotate about a central axis 105. The hub 141 can be joined to a shaft that is co-axial with the hub and with the nacelle 150. The nacelle 150 can house electrical generation equipment therein (not shown). A primary annular airfoil 110, e.g., a turbine shroud, can be in fluid communication with the rotor 142 and can be co-axial with the central axis 105. For example, a fluid stream passing through the primary annular airfoil 110 can also pass through the rotor 142. The primary annular airfoil 110 includes a leading edge 112, also known as the inlet end, which can be substantially annular. The leading edge 112 can provide a relatively narrow gap between the rotor blade 140 tips and the interior surface of the leading edge 112. The plane at which the rotor blades 140 rotate within the inner surface of the primary annular airfoil 110 can define a rotor plane 119 through which a fluid stream can pass.

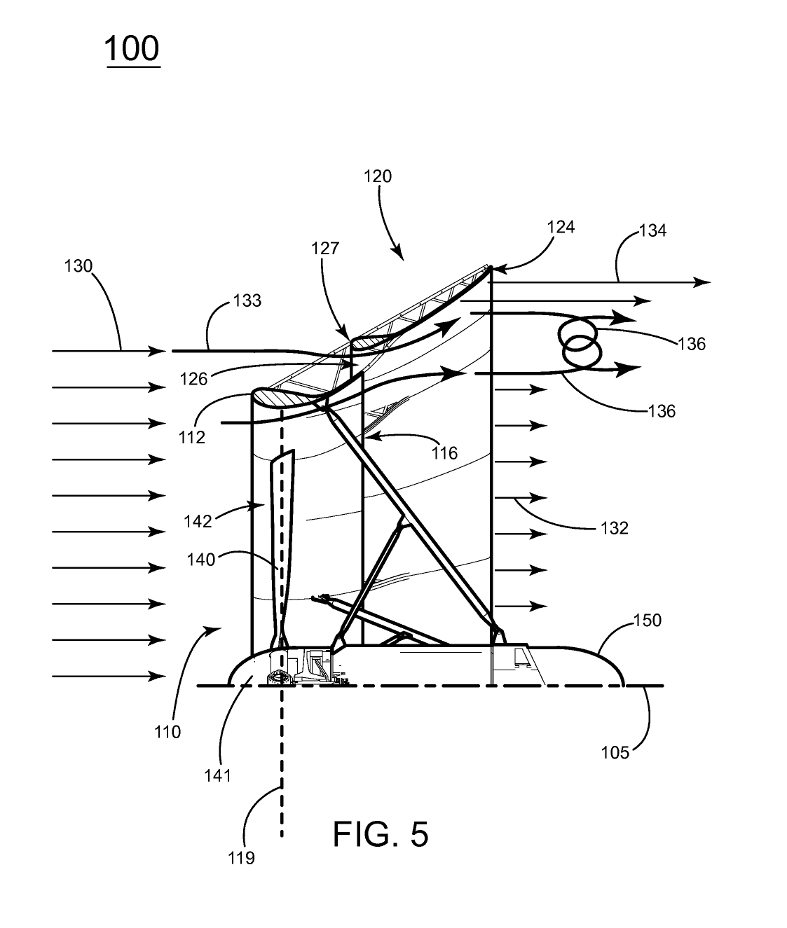

In some embodiments, the leading edge 112 can be engaged with a series of substantially linear segments with substantially constant faceted cross-sections 115a-j, also known as turbine shroud facets, that each transition from the annular leading edge 112. Each of the turbine shroud facets 115a-j can enjoin adjacent turbine shroud facets directly and/or at nodes 117, and can be supported by spars or struts 113. The primary annular airfoil 110 further includes a trailing edge 116, also known as the rear end of the primary annular airfoil 110. In some embodiments, the leading edge 112 can be annular or round and the trailing edge 116 can define linear faceted segments. The primary annular airfoil 110 can transition from the round leading edge 112 to the linear faceted segments of the trailing edge 116, while maintaining a curvature on the inner and outer surfaces of the primary annular airfoil 110. Thus, while the leading edge 112 defines a round structure, the trailing edge 116 of the primary annular airfoil 110 can define a polygonal structure defined by the interconnecting turbine shroud facets 115a-j. In some embodiments, the leading edge 112 can transition into a substantially planar segment at a distance offset from the trailing edge 116, such that a portion of the cross-section of the primary annular airfoil 110 defines a linear faceted segment and/or a constant cross-sectional thickness (e.g., FIG. 5).

A secondary annular airfoil 120, e.g., an ejector shroud, can include substantially linear faceted segments with substantially constant cross-sections 129a-j, otherwise referred to as ejector shroud facets, each including trailing edges 124 and leading edges 127 that can be in fluid communication with the trailing edge 116 of the primary annular airfoil 110. For example, the leading edge 127 of the secondary annular airfoil 120 can be positioned in-line with or partially upstream of the trailing edge 116 of the primary annular airfoil 110. Thus, a fluid stream passing through the primary annular airfoil 110 can pass out of the trailing edge 116 and enter the secondary annular airfoil 120 and/or mix with a fluid stream passing through the secondary annular airfoil 120. Facets 129a-j can enjoin at struts 113 that support the nodes of both annular airfoils 110, 120. In some embodiments, the leading edge 127 and the trailing edge 124 of the ejector shroud 120 can define linear faceted segments, e.g., a polygonal structure defined by the interconnecting ejector shroud facets 129a-j. The linear faceted segment of the leading edge 127 can transition to the linear faceted segment of the trailing edge 124, while maintaining a curvature on the inner and outer surfaces of the secondary annular airfoil 120. In some embodiments, the leading edge 127 can transition into a substantially planar segment at a distance offset from the trailing edge 124, such that a portion of the cross-section of the secondary annular airfoil 120 defines a liner segment and/or a constant cross-sectional thickness (e.g., FIG. 5).

The annular airfoils 110, 120 can be co-axial with the rotor blades 140, central hub 141 and nacelle 150 about the central axis 105. The turbine and annular airfoils 110, 120 can be supported by a tower structure 102. It will be understood that the number of cross-sections (e.g., 115a-j and/or 129a-j) shown in FIGS. 1-4 is illustrative and, in some embodiments, a greater or fewer number of similar cross-sections can be utilized.

FIG. 5 is a detailed, side cross-section view of the fluid turbine 100 of FIG. 4. The primary annular airfoil 110 includes an inlet defined by a leading edge 112 and a trailing edge 116. The secondary annular airfoil 120 includes an inlet defined by leading edge 127 and trailing edge 124. The trailing edge 116 of the primary annular airfoil 110 can be in fluid communication with the leading edge 127 of the secondary annular airfoil 120. For example, the leading edge 127 of the secondary annular airfoil 120 can be positioned in-line with or partially upstream of the trailing edge 116 of the primary annular airfoil 110. Thus, a fluid stream passing through the primary annular airfoil 110 can pass out of the trailing edge 116 and enter the secondary annular airfoil 120 and/or mix with a fluid stream passing through the secondary annular airfoil 120. A rotor 142 can be in fluid communication with the leading edge 112 of the primary annular airfoil 110. In particular, the rotor 142 can be disposed within the primary annular airfoil 110 and the circumference of the rotor blades 140 can define a rotor plane 119 through which a fluid stream can pass. In some embodiments, the rotor 142 can be disposed downstream of the leading edge 112 of the primary annular airfoil 110. The primary annular airfoil 110 and the secondary annular airfoil 120 can be co-axial about the central axis 105.

Ambient flow 130, e.g., a fluid stream, upstream of the primary annular airfoil 110 can be at a maximum fluid velocity μ. Energy can be extracted from the ambient flow 130 that enters the leading edge 112 of the primary annular airfoil 110 by the rotor 142. In particular, at the leading edge 112 of the primary annular airfoil 110, the ambient flow 130 can separate into a first portion 136 which passes through the rotor 142, and a second portion 133 which passes through an open area 126. The open area 126 can be defined by an area of the secondary annular airfoil 120 at the leading edge 127 less an area of the primary annular airfoil 110 at the trailing edge 116. In particular, the open area 126 can be the area between the trailing edge 116 of the primary annular airfoil 110 and the leading edge 127 of the secondary annular airfoil 120.

A resultant flow 132 of the ambient flow 130 that has passed through the rotor 142 can exhibit a pressure that is lower than the ambient flow 130. The resultant flow 132 that has passed through the rotor 142 can be at a minimum velocity, e.g., approximately one-third of the maximum fluid velocity μ. The second portion 133 of the ambient flow 130 that enters the open area 126 at the leading edge 127 of the secondary annular airfoil 120 provides the introduction of bypass flow 134 into the wake, e.g., the resultant flow 132, of the fluid turbine 100. Turbulent mixing between bypass flow 134 and the resultant flow 132 that has passed through the rotor 142 can be represented by arrows 136. Downstream of the fluid turbine 100, the bypass flow 134 and the resultant flow 132 that has passed through the rotor 142 can mix until the fluid stream gradually ascends to the ambient velocity and pressure further downstream of the fluid turbine 100.

A mixer-ejector fluid turbine 100 can inject bypass flow 134 to the resultant flow 132 that has passed through the rotor 142 for the purpose of increasing the pressure in the region downstream of the rotor 142, otherwise referred to as energizing the wake. Increasing the pressure in the region downstream of the rotor 142 can allow greater energy extraction at the rotor 142 than could be extracted by an open rotor or by a duct augmented fluid turbine.

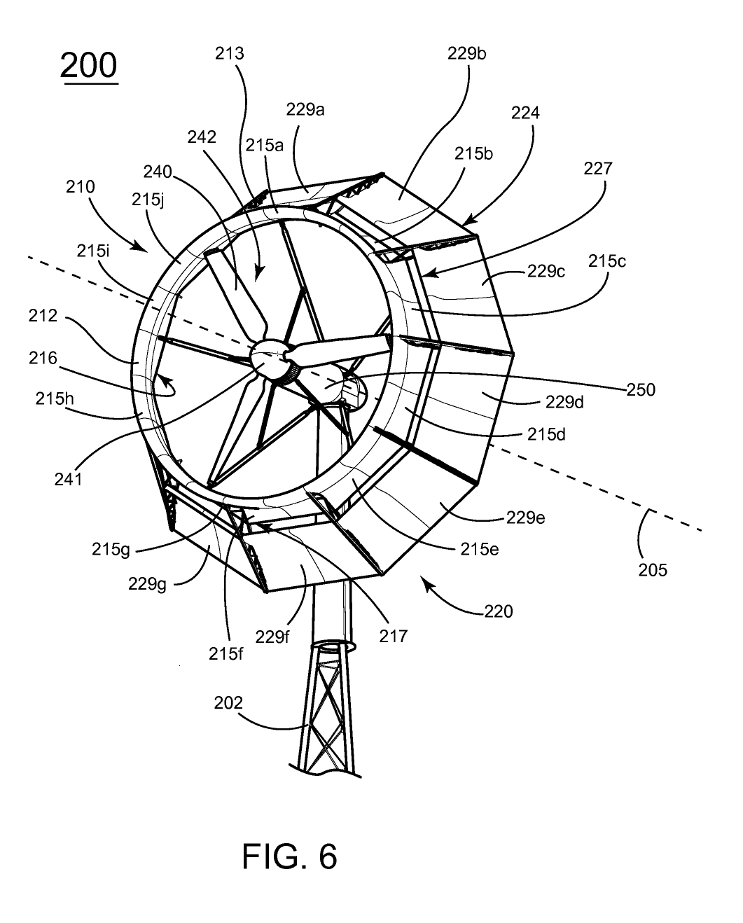

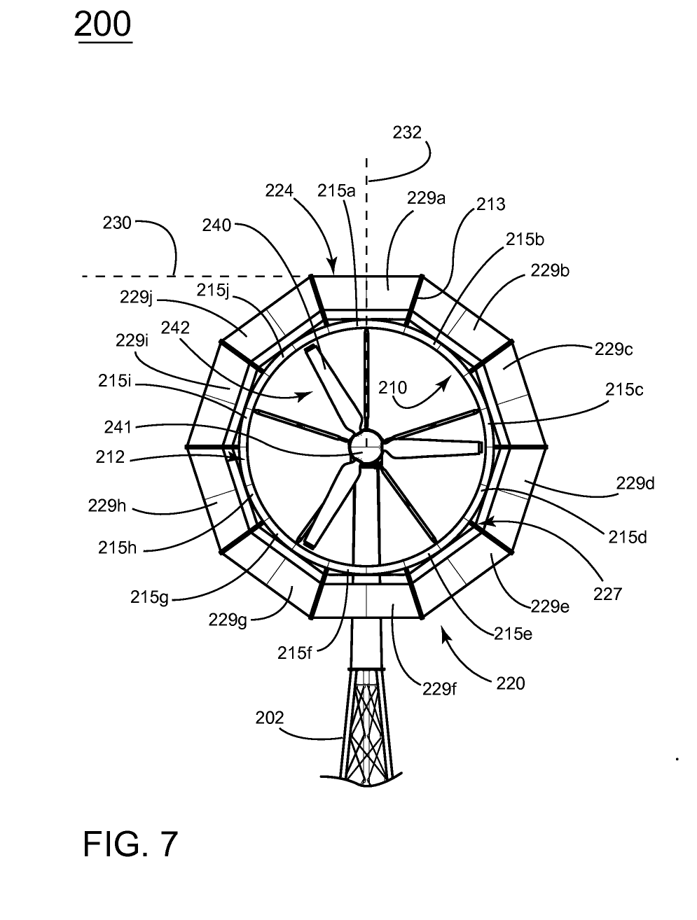

FIG. 6 is a right, front perspective view of another example fluid turbine 200. FIG. 7 is a front, orthographic view of the fluid turbine 200. In particular, FIGS. 6 and 7 illustrate an example embodiment of a fluid turbine 200 in which the facets of the primary annular airfoil 210, e.g., a turbine shroud, and the facets of the secondary annular airfoil 220, e.g., an ejector shroud, are configured with a horizontal facet at the 12:00 o'clock and 6:00 o'clock positions about the annular ringed airfoils 210, 220.

The fluid turbine 200 includes one or more rotor blades 240 that can be joined at a central hub 241 and rotate about a central axis 205. The hub 241 can be joined to a shaft that can be co-axial with the hub 241 and with the nacelle 250. The nacelle 250 can house electrical generation equipment therein (not shown). A primary annular airfoil 210 can be in fluid communication with the rotor 242 and can be co-axial with the central axis 205. Thus, a fluid stream passing through the primary annular airfoil 210 can also pass through the rotor 242. The primary annular airfoil 210 includes a leading edge 212, also known as the inlet end, that can be substantially annular, thereby providing a relatively narrow gap between the rotor blade 240 tips and the interior surface of the leading edge 212. The area in which the rotor blades 240 rotate can define a rotor plane 119 through which a fluid stream can pass.

In some embodiments, the leading edge 212 can be engaged with a series of substantially linear faceted segments with substantially constant cross-sections 215a-j, also known as turbine shroud facets, that each transition from the annular leading edge 212. Each of the turbine shroud facets 215a-j can enjoin adjacent turbine shroud facets directly and/or at nodes 217, are supported by spars or struts 213, and include trailing edge 216, also known as the exit or rear end of the annular airfoil 210. For example, the leading edge 212 can be round while the trailing edge 216 defines linear faceted segments. The linear faceted segments can define a polygonal shape. In some embodiments, the round leading edge 212 can transition to the linear faceted trailing edge 216, while maintaining a curvature of the inner and outer surfaces of the primary annular airfoil 210.

A secondary annular airfoil 220 includes substantially linear faceted segments with constant cross-sections 229a-j, otherwise referred to as ejector shroud facets, which include trailing edges 224 and leading edges 227 that can be in fluid communication with the trailing edge 216 of the primary annular airfoil 210. For example, the leading edge 227 of the secondary annular airfoil 220 can be positioned in-line with or partially upstream of the trailing edge 216 of the primary annular airfoil 210. Thus, a fluid stream passing through the primary annular airfoil 210 can pass out of the trailing edge 216 and enter the secondary annular airfoil 220 and/or mix with a fluid stream passing through the secondary annular airfoil 220. Ejector shroud facets can enjoin at struts 213 that support the nodes of both annular airfoils 210, 220. The annular airfoils 210, 220 can be co-axial with the rotor 242, the central hub 241 and the nacelle 250 about the central axis 205. The turbine and annular airfoils 210, 220 can be supported by a tower structure 202. It will be understood that the number of cross-sections (e.g., 215a-j and/or 229a-j) discussed and shown herein is illustrative and, in some embodiments, a greater or fewer number of similar cross-sections can be utilized.

In some embodiments, as shown in FIG. 7, the fluid turbine 200 can define a vertical axis 232 that is perpendicular to the central axis 250. The fluid turbine 200 can further define a horizontal axis 230 which is parallel with and substantially linear with the trailing edge 224 segment of the secondary annular airfoil 220 at the top of the fluid turbine 100. In some embodiments, the vertical axis 232 can be substantially perpendicular to the horizontal axis 230 (and the trailing edge 224 of the fluid turbine 100 at the cross-section 229a).

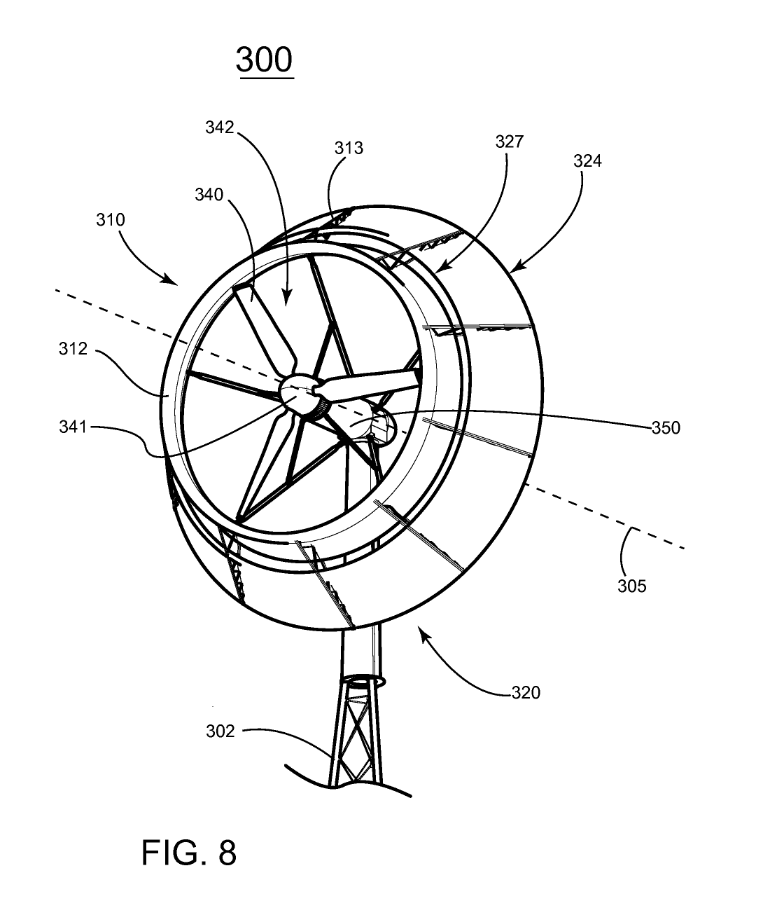

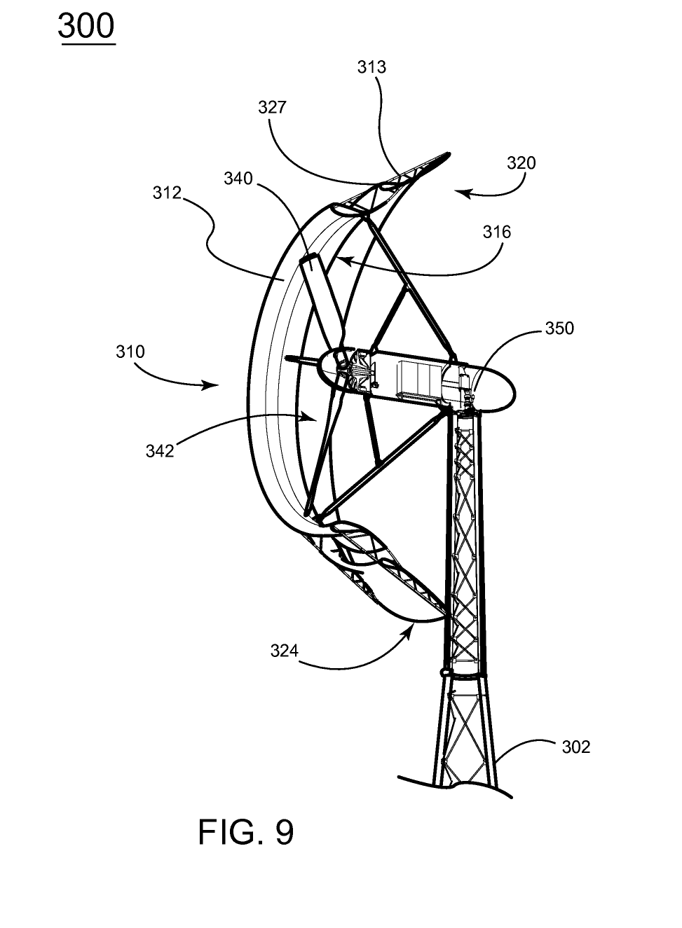

FIG. 8 is a right, front perspective view of another example fluid turbine 300. FIG. 9 is a front, right, perspective, cut-away view of the fluid turbine 300. The fluid turbine 300 includes rotor blades 340 that are joined at a central hub 341 and rotate about a central axis 305. The central hub 341 can be joined to a shaft that can be co-axial with the hub 341 and with a nacelle 350. The nacelle 350 can house electrical generation equipment therein (not shown). A primary annular airfoil 310, e.g., a turbine shroud, can be in fluid communication with the rotor 342 and can be co-axial with the central axis 305. Thus, a fluid stream passing through the primary annular airfoil 310 can also pass through the rotor 342. The primary annular airfoil 310 includes a leading edge portion 312, also known as the inlet end, and a trailing edge portion 316, also known as the exit of the annular airfoil 310. The primary annular airfoil 310 can be supported by spars or struts 313 that are further engaged with a secondary annular airfoil 320, e.g., an ejector shroud.

The secondary annular airfoil 320 includes a trailing edge 324 and a leading edge 327 that can be in fluid communication with the trailing edge 316 of the primary annular airfoil 310. The turbine and annular airfoils 310, 320 can be supported by a tower structure 302. For example, the leading edge 327 of the secondary annular airfoil 320 can be positioned in-line with or partially upstream of the trailing edge 316 of the primary annular airfoil 310. Thus, a fluid stream passing through the primary annular airfoil 1310 can pass out of the trailing edge 316 and enter the secondary annular airfoil 320 and/or mix with a fluid stream passing through the secondary annular airfoil 320.

The mixing of the bypass flow and the resultant flow that has passed through the rotor can occur similarly in example fluid turbines discussed herein. Mixing of the bypass flow and the resultant flow can increase the pressure downstream of the fluid turbine, thereby increasing the energy extracted at the rotor. Faceted annular airfoils can also provide a low cost manufacturing method that relies on flat stock material or extruded forms in place of molded round forms.

While example embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A fluid turbine, comprising:
a turbine shroud including an inlet defined by a leading edge and an outlet defined by a trailing edge, the leading edge of the turbine shroud being round and the trailing edge of the turbine shroud including faceted segments,
a rotor disposed within the turbine shroud, the rotor including a hub and at least one rotor blade engaged with the hub, the rotor defining a rotor plane, and the turbine shroud providing a first portion of a fluid stream to the rotor plane via the inlet of the turbine shroud, and
an ejector shroud including an ejector shroud inlet and an ejector shroud outlet, the ejector shroud inlet being in fluid communication with the outlet of the turbine shroud, and the ejector shroud providing a second portion of the fluid stream to the outlet of the turbine shroud via an open area, the open area being defined by an area of the ejector shroud inlet less an area of the outlet of the turbine shroud.

2. The fluid turbine according to claim 1, wherein the rotor is disposed downstream of the inlet of the turbine shroud.

3. The fluid turbine according to claim 1, wherein the faceted segments comprise a plurality of linear and constant cross-section segments.

4. The fluid turbine according to claim 1, wherein the ejector shroud inlet defines an ejector shroud leading edge and the ejector shroud outlet defines an ejector shroud trailing edge.

5. The fluid turbine according to claim 4, wherein the ejector shroud leading edge and the ejector shroud trailing edge comprise faceted segments.

6. The fluid turbine according to claim 5, wherein the faceted segments comprises a plurality of linear and constant cross-section segments.

7. The fluid turbine according to claim 1, wherein the ejector shroud comprises faceted segments horizontally oriented and positioned at a 12:00 o'clock and a 6:00 o'clock position.

8. The fluid turbine according to claim 1, wherein the second portion of the fluid stream is a bypass flow.

9. The fluid turbine according to claim 8, wherein the ejector shroud provides the bypass flow to a resultant flow wake of the first portion of the fluid stream of the fluid turbine to increase a pressure downstream of the rotor.

10. The fluid turbine according to claim 1, wherein the ejector shroud increases a unit mass flow through the turbine shroud by increasing a camber of the turbine shroud.

11. The fluid turbine according to claim 10, wherein increasing the camber of the turbine shroud increases a lift coefficient on an inner surface of the turbine shroud.

12. A method of operating a fluid turbine, comprising:
providing a fluid turbine, the fluid turbine including (i) a turbine shroud including an inlet defined by a leading edge and an outlet defined by a trailing edge, the leading edge of the turbine shroud being round and the trailing edge of the turbine shroud including faceted segments, (ii) a rotor disposed within the turbine shroud, the rotor including a hub and at least one rotor blade engaged with the hub, the rotor defining a rotor plane, and the turbine shroud providing a first portion of a fluid stream to the rotor plane via the inlet of the turbine shroud, and (iii) an ejector shroud including an ejector shroud inlet and an ejector shroud outlet,
positioning the ejector shroud inlet in fluid communication with the outlet of the turbine shroud,
providing a first portion of a fluid stream to the rotor plane via the inlet of the turbine shroud, and
providing a second portion of the fluid stream to the outlet of the turbine shroud via an open area, the open area being defined by an area of the ejector shroud inlet less an area of the outlet of the turbine shroud.

13. The method according to claim 12, comprising providing bypass flow with the ejector shroud to a resultant flow wake of the first portion of the fluid stream downstream of the outlet of the turbine shroud.

14. The method according to claim 13, wherein providing bypass flow comprises increasing a pressure downstream of the rotor by creating turbulent mixing between the bypass flow and the resultant flow wake.

15. The method according to claim 14, wherein increasing the pressure downstream of the rotor allows greater energy extraction at the rotor from the fluid stream.

16. The method according to claim 12, comprising increasing a unit mass flow through the turbine shroud with the ejector shroud by increasing a camber of the turbine shroud.

17. The method according to claim 16, wherein increasing the camber of the turbine shroud comprises increasing a lift coefficient on an inner surface of the turbine shroud.

18. A fluid turbine, comprising:
a turbine shroud including an inlet and an outlet,
a rotor disposed within the turbine shroud, the rotor including a hub and at least one rotor blade engaged with the hub, the rotor defining a rotor plane, and the turbine shroud providing a first portion of a fluid stream to the rotor plane via the inlet of the turbine shroud, and
an ejector shroud including an ejector shroud inlet defined by a leading edge and an ejector shroud outlet defined by a trailing edge, the leading edge and the trailing edge of the ejector shroud including faceted segments, the ejector shroud inlet being in fluid communication with the outlet of the turbine shroud, and the ejector shroud providing a second portion of the fluid stream to the outlet of the turbine shroud via an open area, the open area being defined by an area of the ejector shroud inlet less an area of the outlet of the turbine shroud.

19. The fluid turbine according to claim 18, wherein the inlet of the turbine shroud defines a turbine shroud leading edge and the outlet of the turbine shroud defines a turbine shroud trailing edge.

20. The fluid turbine according to claim 19, wherein the turbine shroud leading edge is round and the turbine shroud trailing edge comprises faceted segments.
